(19) United States
(12) Patent Application Publication
(10) Pub. No.: US 2005/0253734 A1
(43) Pub. Date: Nov. 17, 2005

(54) Communication device

(75) Inventors: Masashi Ikeura, Hirakata-shi (JP); Takehiro Kagatani, Toyonaka-shi (JP); Yasushi Kamiyama, Soraku-gun (JP); Yoshiki Taketa, Moriguchi-shi (JP)

Correspondence Address: RATNERPRESTIA, P O BOX 980, VALLEY FORGE, PA, 19482-0980, US

(73) Assignee: MATSUSHITA ELECTRIC INDUSTRIAL CO., LTD.

(21) Appl. No.: 11/122,339

(22) Filed: May 5, 2005

(30) Foreign Application Priority Data
May 13, 2004 (JP) 2004-143452

(51) Int. Cl. H05B 37/02

(52) U.S. Cl. 340/825.57

(57) ABSTRACT

A communication device includes an oscillator oscillated with a predetermined frequency and an oscillation circuit for exciting and oscillating the oscillator. The communication device also includes a receiving circuit for receiving a signal from outside that is superposed with a carrier wave. A receiving circuit outputs a signal from which the carrier wave is removed. The communication device also includes a reception section power source switching circuit for switching whether or not power is supplied to the receiving circuit and the microcomputer as a control means for controlling the switching. The microcomputer is connected to the oscillation circuit and starts, immediately after detecting the oscillation of oscillation circuit, the detection of an output signal of the receiving circuit.

### FIELD OF THE INVENTION

The present invention relates to a communication device. In particular, the present invention relates to a communication device vehicle suitable for the remote control of locking and unlocking of a door of a vehicle.

### BACKGROUND ART

With the recent automobiles having sophisticated functions, batteries used for power sources of car navigations and communication devices have been commonly used by other various devices in an increasing manner. Due to this reason, vehicles such as automobiles have been desired to reduce the power consumption particularly when the engine is stopped.

A conventional communication device will be described with reference to FIG. 3 and FIG. 4.

FIG. 3 is a circuit block diagram of a conventional communication device. Communication device 100 includes oscillator 1 that has, for example, a center frequency of 4.75 MHz and that is provided by crystal or ceramic. Oscillator 1 is connected with oscillation circuit 2.

Communication device 100 also includes receiving circuit 50. Receiving circuit 50 includes frequency multiplier circuit 3, first amplifier 5, mixer 6, second amplifier 7, filter 8, detection circuit 9, and third amplifier 10. Receiving circuit 50 also includes antenna 4.

Antenna 4 is provided in a vehicle (not shown) and receives a predetermined electromagnetic wave signal from an external mobile device (not shown) as an input signal. First amplifier 5 amplifies the input signal received by the antenna 4. The input side of mixer 6 is connected to first amplifier 5. Second amplifier 7 amplifies an output signal from mixer 6. Filter 8 extracts a signal having a predetermined frequency component from the signal from second amplifier 7. Detection circuit 9 detects the signal having a predetermined band extracted by filter 8. Detection circuit 9 outputs a voltage of about 2V when detecting a signal having a predetermined frequency component and outputs a voltage of about 0V when detecting no such signal.

Third amplifier 10 amplifies a voltage from detection circuit 9 to have a predetermined magnitude. For example, third amplifier 10 amplifies a voltage of 2V to 5V. The output voltage from third amplifier 10 is used as a control voltage for microcomputer 12.

Microcomputer 12 is provided by CMOS, for example. Communication device 100 includes second oscillator 13, power source 14, and power source switching circuit 15.

FIG. 4 shows a timing at which power source switching circuit 15 provides switching when an engine in a vehicle (not shown) for example is stopped and all of the doors are closed. Power source switching circuit 15 is controlled by microcomputer 12. Microcomputer 12 controls power source switching circuit 15 so that a power source voltage supplied from power source 14 is supplied via power source switching circuit 15 to receiving circuit 50 and oscillation circuit 2 intermittently. The intermittent supply is performed with cycle T4 of 200 ms for example and power distribution time T4a is set to be 20 ms for example so that power is supplied to receiving circuit 50 and oscillation circuit 2 intermittently.

In power distribution time T4a during which power is supplied, oscillation stabilization time T4b until which the oscillation of oscillator 1 is started generally requires a time from about 2 ms to about 6 ms. However, this oscillation stabilization time T4b is frequently set to have about 10 ms as a power distribution time so that a certain margin can be obtained to provide a stabilized circuit operation.

In power distribution time T4a of 20 ms, the first half of 10 ms is oscillation stabilization time T4b and the second half of 10 ms is signal detection time T4c during which whether a vehicle receives a unique signal from an external mobile device or not is detected.

When a vehicle (not shown) receives a unique signal from an external mobile device, microcomputer 12 outputs a predetermined signal to a body control means (not shown) of the vehicle. The body control means of the vehicle detects this signal to perform locking or unlocking of a door of the vehicle.

Prior art related to the locking and unlocking of the vehicle and the saving of a battery are introduced, for example, in the specifications of Japanese Patent Unexamined Publication No. 6-219154 and U.S. Patent Publication No. 4857917.

However, in the conventional communication device, in order to stabilize the operation of the circuit, oscillation stabilization time T4b of oscillator 1 is frequently set to have 10 ms that is sufficiently longer than the actually-required oscillation stabilization time of 2 ms to 6 ms. Thus, the conventional communication device has not yet achieved the objective of saving power.

### DISCLOSURE OF THE INVENTION

The communication device of the present invention includes an oscillator oscillated with a predetermined frequency and an oscillation circuit for electrically exciting the oscillator. The communication device also includes a receiving circuit. The receiving circuit outputs a signal obtained by removing, from a reception signal from outside superposed with a carrier wave, this carrier wave. The communication device also includes a reception section power source switching circuit for switching whether or not power is supplied to the receiving circuit and a control means for controlling the reception section power source switching circuit. The control means is connected to the oscillation circuit and starts, immediately after detecting the oscillation of the oscillation circuit, the detection of an output signal of the receiving circuit, thereby constituting the communication device. In this way, the control means starts the detection of an output signal of the receiving circuit immediately after detecting the oscillation of the oscillation circuit. As a result, when the oscillation stabilization time is shorter than 10 ms for example, the power distribution time can reduced accordingly, thus providing a communication device that does not consume power of the battery in a wasteful manner to realize power saving.

The communication device of the present invention also includes an oscillation section power source switching circuit for switching whether or not power is supplied to the oscillation circuit. When the oscillation of the oscillation circuit is not detected even when a predetermined time has passed since the control means turns ON the oscillation section power source switching circuit, this oscillation section power source switching circuit is turned OFF, and then it turned ON. Even when the power source voltage is reduced and the oscillator has a status deviating from the stabilized oscillation status for example, the control circuit supplies to the oscillator a transitional power source voltage caused at the OFF/ON operation to excite the oscillator again, thereby returning the status of the oscillator to a regular oscillation status. As a result, the oscillator can have prolonged duration of use and service life.

### BRIEF DESCRIPTION OF THE DRAWINGS

FIG. 1 is a circuit block diagram illustrating the main part of a communication device according to an embodiment of the present invention.

FIG. 2 is a switching timing diagram of a receiving circuit and an oscillation section power source switching circuit of the communication device.

FIG. 3 is a circuit block diagram of a conventional communication device.

FIG. 4 is a switching timing diagram of a power source switching circuit of the conventional communication device of FIG. 3.

### DETAILED DESCRIPTION

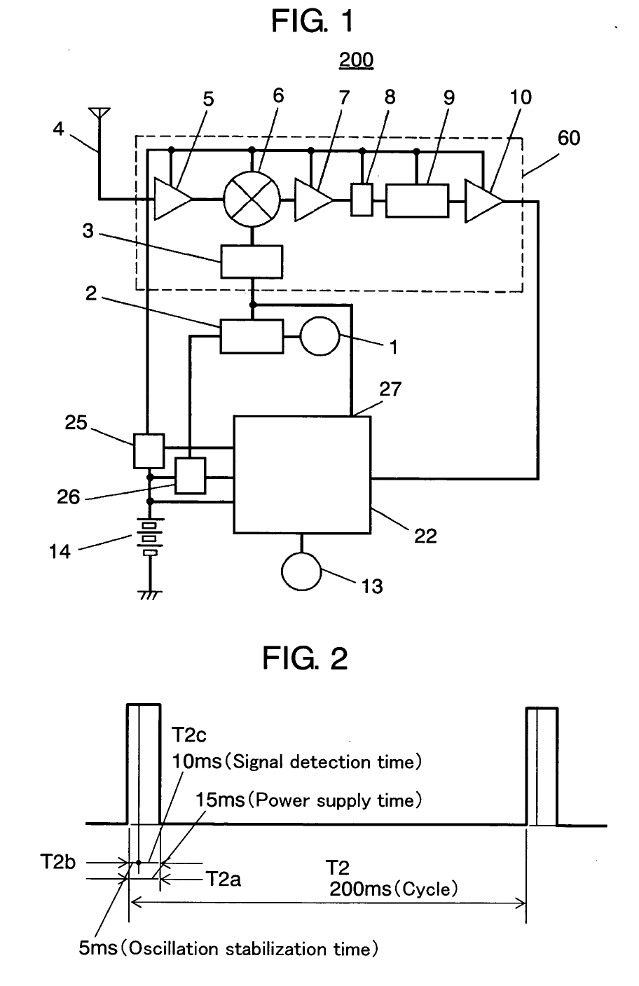

Hereinafter, embodiments of the present invention will be described with reference to FIG. 1 and FIG. 2.

FIG. 1 is a circuit block diagram illustrating communication device 200 according to an embodiment of the present invention. Communication device 200 includes oscillator 1 that oscillates with a center frequency of 4.75 MHz and that is provided by crystal or ceramic, for example. Oscillator 1 is connected with oscillation circuit 2. When oscillation circuit 2 is supplied with power, oscillator 1 is excited to generate a signal having a predetermined oscillation frequency.

Frequency multiplier circuit 3 multiplies the oscillation frequency of 4.75 MHz for example generated by oscillation circuit 2 to be a frequency of 304.3 MHz (that is 64 times larger than 4.75 MHz) to output the frequency.

In addition to receiving circuit 60, communication device 200 also includes antenna 4. Antenna 4 is provided in a vehicle and receives, as an input signal, an electromagnetic wave signal that is sent from an external mobile device (not shown) and that is subjected to an amplitude modulation by a carrier wave of 315 MHz for example to be unique to the vehicle.

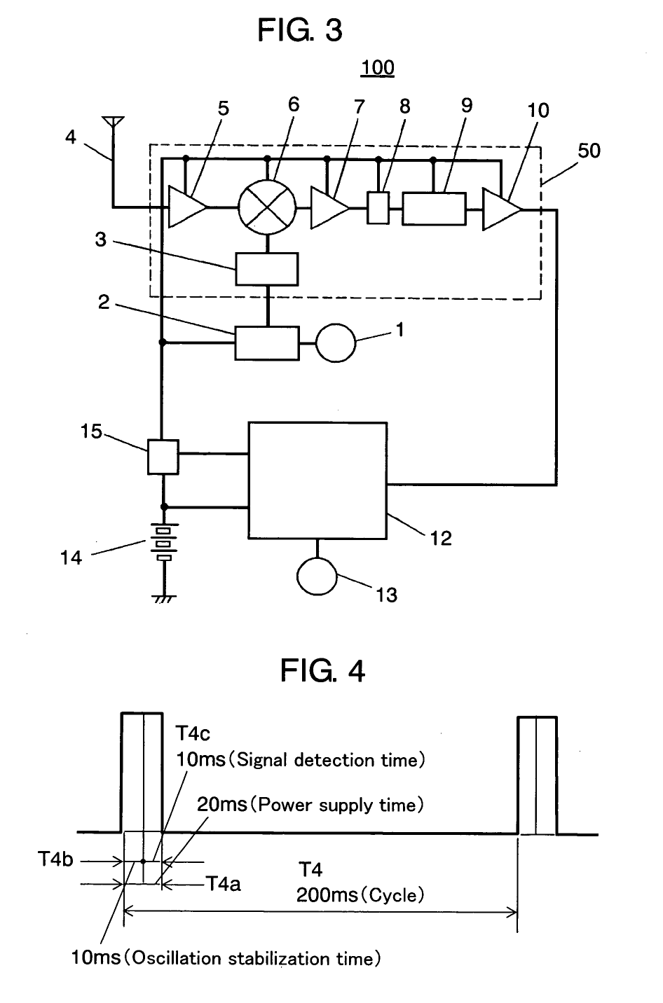

Receiving circuit 60 has the same structure as that of the conventional receiving circuit shown in FIG. 3. Specifically, receiving circuit 60 includes frequency multiplier circuit 3, first amplifier 5, mixer 6, second amplifier 7, filter 8, detection circuit 9, and third amplifier 10. The electromagnetic wave signal received by antenna 4 is amplified by first amplifier 5. The output signal amplified by first amplifier 5 is inputted to mixer 6. Mixer 6 provides a subtraction processing to the output signal from first amplifier 5 and the output signal from frequency multiplier circuit 3. Specifically, these signals are converted to be signals having a frequency of “(315 MHz-304.3 MHz)=10.7 MHz” and are outputted from the output side of mixer 6.

Second amplifier 7 is inputted with the output signal from mixer 6 and amplifies the signal to have a predetermined magnitude. Filter 8 is a so-called frequency band filter that receives the output signal from second amplifier 7 to extract a frequency component of 10.7 MHz of the carrier wave for example.

Detection circuit 9 detects a signal having the frequency component of 10.7 MHz extracted by filter 8. When detecting the frequency component of 10.7 MHz correctly, detection circuit 9 outputs a voltage of about 2 V for example. When not detecting the frequency component of 10.7 MHz, detection circuit 9 outputs a voltage of almost 0 (zero) V. Specifically, when the vehicle receives a predetermined carrier wave, detection circuit 9 outputs a signal voltage in accordance with a unique signal.

When receiving the output voltage outputted from detection circuit 9, third amplifier 10 amplifies the voltage to have a predetermined magnitude. For example, when receiving a voltage of 2 V from detection circuit 9, third amplifier 10 amplifies the voltage to have a magnitude of 5 V for example. The output voltage outputted from third amplifier 10 is used as a control voltage for controlling microcomputer 22 connected to third amplifier 10.

Communication device 200 further includes microcomputer 22 provided by CMOS for example and also includes second oscillator 13. Second oscillator 13 is an oscillator made by crystal or ceramic that is connected to an oscillation circuit included in microcomputer 22 and that is oscillated with a frequency of 25 MHz for example. When power (power source voltage) is supplied from power source 14 to microcomputer 22, second oscillator 13 is oscillated. When being supplied with power from a battery (not shown) of a vehicle, power source 14 has a power source voltage converted to 5 V for example. Reception section power source switching circuit 25 is connected to power source 14, receiving circuit 60 and microcomputer 22. Microcomputer 22 is supplied with power from power source 14 and controls reception section power source switching circuit 25. Reception section power source switching circuit 25 has a function to switch whether or not a power source voltage is supplied to receiving circuit 60.

Oscillation section power source switching circuit 26 is connected to power source 14, oscillation circuit 2, and microcomputer 22. Microcomputer 22 controls oscillation section power source switching circuit 26 and has a function to switch whether or not a power source voltage (power) of power source 14 is supplied to oscillation circuit 2.

Input terminal 27 of microcomputer 22 is connected to the output side of oscillation circuit 2. Microcomputer 22 detects a voltage of input terminal 27 to determine whether oscillator 1 is oscillated correctly or not. For example, when power supply voltage is 5 v, the voltage of the input terminal 27 is more than 2.5 v, a microcomputer 22 detects which the oscillation of oscillator 1 was stabilized.

Microcomputer 22 simultaneously turns ON reception section power source switching circuit 25 and oscillation section power source switching circuit 26 to simultaneously supply power to receiving circuit 60 and oscillation circuit 2. Thereafter, microcomputer 22 detects a voltage of input terminal 27.

Then, microcomputer 22 simultaneously turns OFF reception section power source switching circuit 25 and oscillation section power source switching circuit 26. Thereafter, when a vehicle (not shown) receives and detects a signal from an external mobile device, a body control means (not shown) included in the vehicle outputs a predetermined signal. The body control means of the vehicle detects this signal to lock or unlock the door of the vehicle.

FIG. 2 shows a timing at which reception section power source switching circuit 25 and oscillation section power source switching circuit 26 are switched when an engine of a vehicle (not shown) is stopped and the doors are all closed.

As shown in FIG. 2, microcomputer 22 performs an operation for simultaneously turning ON or OFF reception section power source switching circuit 25 and the oscillation section power source switching circuit with a cycle of 200 ms for example. When the engine of the vehicle is stopped and the doors are closed, microcomputer 12 supplies the power from power source 14 via reception section power source switching circuit 25 to receiving circuit 60 in an intermittent manner. Microcomputer 12 also supplies power to oscillation circuit 2 with cycle T2 of 200 ms and power distribution time T2a of 20 ms in an intermittent manner.

After the start of the oscillation of oscillator 1, when the oscillation is detected in oscillation stabilization time T2b of 5 ms (which is the first half part of power distribution time T2a of 15 ms) for example, then the output voltage of third amplifier 10 is detected in signal detection time T2c of 10 ms (which is the second half part) has passed. As a result, whether a vehicle (not shown) receives a unique signal from an external mobile device or not can be detected.

When oscillation stabilization time T2b of oscillator 1 is 5 ms for example, this oscillation stabilization time T2b can be reduced from 10 ms to 5 ms, thus preventing wasteful power consumption.

The power control of the present invention as described above is clearly different from the conventional power supply method in which oscillation stabilization time T2b from the supply of power to the start of oscillation of oscillator 1 generally requires about 2 ms to about 6 ms and thus is set to have 10 ms including a small amount of margin.

As described above, the communication device according to the embodiment of the present invention includes receiving circuit 60 that uses an output from oscillation circuit 2 for oscillating oscillator 1 that can be oscillated with a predetermined frequency to output a signal obtained by removing, from a signal superposed with a carrier wave from outside, this carrier. The communication device also includes reception section power source switching circuit 25 for switching whether or not power is supplied to receiving circuit 60 and microcomputer 22 as a control means for controlling the switching.

Furthermore, microcomputer 22 is connected to oscillation circuit 2 and constitutes the communication device such that, immediately after the detection of the oscillation of oscillation circuit 2, microcomputer 22 starts the detection of an output signal of receiving circuit 60.

In this way, microcomputer 22 starts, immediately after detecting the oscillation of oscillation circuit 2, the detection of an output signal of receiving circuit 60. As a result, when oscillation stabilization time is shorter than 10 ms for example, the power distribution time can reduced accordingly, thus providing a communication device that does not consume power in a wasteful manner.

The communication device also includes oscillation section power source switching circuit 26 for switching whether or not power is supplied to oscillation circuit 2. When microcomputer 22 cannot detect the oscillation of oscillation circuit 2 even when a predetermined time has passed since microcomputer 22 has turned ON oscillation section power source switching circuit 26, microcomputer 22 turns ON or OFF oscillation section power source switching circuit 26. As a result, even when the power source voltage is reduced to suppress oscillator 1 from being excited for example, a transitional power source voltage immediately after the start-up by the OFF/ON that is higher than a power source voltage in the steady state can be supplied, thus promoting the excitation of oscillator 1. This can extend a period during which oscillator 1 can be used.

When oscillator 1 is not oscillated even when the above OFF/ON is performed a predetermined number of times, microcomputer 22 judges that oscillator 1 has a failure to output a predetermined signal to the vehicle body control means and the vehicle body control means detects this predetermined signal. This detection signal may be displayed on an instrument panel for example in a predetermined manner. In this case, when a user cannot remotely control the locking and unlocking of the vehicle door in spite of the operation of the mobile device, the cause of the defect or the details of the failure can be notified to a related party or a person in charge of repairs.

There may be a case in which oscillator 1 has an output signal having a frequency that is higher than that of an output signal of the second oscillator 13 to prevent microcomputer 22 from correctly detecting the frequency of an output signal of oscillator 1. In such a case, a second mixer (not shown) may be provided between the output of oscillator 1 and the output of second oscillator 13 for subtracting, from an output signal of oscillator 1, an output signal of second oscillator 13 to output the result, for example. The configuration as described above in which the output of the second mixer having a low frequency is detected by microcomputer 22 also can provide the effect by the present invention.

### INDUSTRIAL APPLICABILITY

The communication device according to the present invention can provide a communication device that saves power in a battery included in a vehicle to realize power saving. Thus, the present communication device is particularly useful as a communication device for remotely controlling the locking and unlocking a vehicle door, thus providing high industrial applicability.

1. A communication device comprising:
an oscillator;
an oscillation circuit for oscillating this oscillator;
a receiving circuit that uses an output from this oscillation circuit to output a signal obtained by removing, from a signal superposed with a carrier wave from outside, this carrier;
a reception section power source switching circuit for switching whether or not power is supplied to this receiving circuit; and
a control means for controlling the switching of the receiving circuit and the reception section power source switching circuit,
wherein the control means is connected to the oscillation circuit and starts, immediately after detecting the oscillation of the oscillation circuit, the detection of an output signal of the receiving circuit.

2. The communication device according to claim 1, wherein the communication device includes an oscillation section power source switching circuit for switching whether or not power is supplied to the oscillation circuit and, when the oscillation of the oscillation circuit is not detected even when a predetermined time has passed since the control means turns ON the oscillation section power source switching circuit, the oscillation section power source switching circuit is turned OFF or ON.
